(19) United States
(12) Patent Application Publication
(10) Pub. No.: US 2020/0267960 A1
(43) Pub. Date: Aug. 27, 2020

(54) DUAL HOOF PICK SYSTEM AND METHOD

(71) Applicant: Melissa A. Moffett, Fort Gibson, OK (US)

(72) Inventor: Melissa A. Moffett, Fort Gibson, OK (US)

(21) Appl. No.: 16/676,358

(22) Filed: Nov. 6, 2019

Related U.S. Application Data
(60) Provisional application No. 62/735,789, filed on Sep. 24, 2018.

(51) Int. Cl. A01L 15/00; A01L 11/00

(52) U.S. Cl. CPC A01L 15/00; A01L 11/00

(57) ABSTRACT

A horse care product which may be designed to include a hoof pick, a reservoir to store hoof dressing, and a brush for a one-handed applicator. A shut-off may be included for the reservoir. The dual hoof pick may allow a user to easily clean and grease and animal hoof. The device provides horse owners with a uniquely-designed combination pick and brush used to dispense and apply oil and remove debris with a single tool. The device includes a hinged section designed to receive and store oil for dispensing, eliminating the need for separate containers in order to apply oil to dress the hoof.

### CROSS-REFERENCE TO RELATED APPLICATION(S)

The present application is related to and claims priority to U.S. Provisional Patent Application No. 62/735,789 filed Sep. 24, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of farriery of existing art and more specifically relates to farriery tools.

### RELATED ART

Horse hoof care is important to maintaining a healthy horse. Often, multiple tools are needed to complete hoof care. Containers full of oil must be taken to apply the oil to the hoof. People often overuse oil, essentially wasting copious amounts of the product over time which may be expensive. A pick must be used to remove debris from the hoof. It can be difficult to maneuver a horse's hoof while simultaneously trying to soak a brush in oil and then brush the hoof. Overall, it can take a considerable amount of time to perform hoof care. A suitable solution is desired.

U.S. Pat. No. 5,168,935 to Dean J. Thornbury and James P. Thornbury relates to a horse hoof pick including applicator. The described horse hoof pick including applicator is a maintenance device for hooves, such as horse hooves, which includes a hoof pick and a hoof dressing applicator including dressing. The hoof pick handle includes a tubular section having an internal cavity containing hoof liquid dressing. A dressing dispensing applicator on the other end of the handle applies the dressing to a hoof. A cap covers the applicator so that the dressing is not unintentionally dispensed. An exemplary embodiment includes a spray pump dressing applicator. In another exemplary embodiment, a dabber is used as a dressing applicator.

### SUMMARY OF THE INVENTION

In view of the foregoing disadvantages inherent in the known farriery tool art, the present disclosure provides a novel dual hoof pick system. The general purpose of the present disclosure, which will be described subsequently in greater detail, is to provide horse owners with a uniquely-designed combination pick and brush used to dispense and apply oil and remove debris with a single tool.

The device includes a hinged section designed to receive and store oil for dispensing, effectively eliminating the need for separate containers in order to apply oil to ‘dress’ the hoof. The device utilizes stainless steel (preferably) for the pick (other materials such as carbon steel or the like may be used), maximizing durability and longevity of use for removing debris from the hoof. The device saves extensive amounts of time when taking care of horse hooves, reducing the number of independent tools and containers to perform maintenance and care on the hoof. The present invention reduces the amount of oil needed to dress hooves, effectively ensuring users can dispense a perfect amount of oil each time.

A dual hoof pick system is disclosed herein, the system broadly comprising: a dual hoof pick assembly having a tool-body including a handle; an interior volume; a first-brush; a second-brush; and a pick; wherein the dual hoof pick assembly is configured for removing debris from and dispensing oil to at least one hoof of an animal such as a horse.

According to another embodiment, a method of use is also disclosed herein for the dual hoof pick system including providing a dual hoof pick assembly having a tool-body including a handle; an interior volume; a first-brush; a second-brush; a hinged cap; a dispensing button; and a pick (comprising preferably stainless steel); cleaning debris from at least one hoof of a horse; and applying the oil to the at least one hoof of the horse. The method may further comprise the step of refilling additional-oil into the tool-body as needed for dispensing. Preferred embodiments have the hoof dressing brush at the top (under the attached flipped top cap) which may be made from boar's hair or a natural type of bristle, not silicone in preferred embodiments.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dual hoof pick system, constructed and operative according to the teachings of the present disclosure.

FIG. 1 is a perspective view of the dual hoof pick system during an ‘in-use’ condition, according to an embodiment of the disclosure.

FIG. 2 is a perspective view of dual hoof pick system of FIG. 1, according to an embodiment of the present disclosure.

FIG. 3 is a perspective view of the first-brush of the dual hoof pick system of FIG. 1, according to an embodiment of the present disclosure.

FIG. 4 is a perspective view of the pick of the dual hoof pick system of FIG. 1, according to an embodiment of the present disclosure.

FIG. 5 is a perspective view showing how oil may be added to the dual hoof pick system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a farriery tool and more particularly to a dual hoof pick system as used to improve the care of horse hooves.

Generally, the dual hoof pick system is an improved horse care tool utilized for taking care of horse hooves. The device is comprised of a hand tool with an open volume within the handle closed via a hinged cap, a boars-hair brush, a hoof brush, and a stainless steel pick. The boards-hair brush can be protected via a plastic hinged cap and a button near the brush can be used to dispense oil from the interior volume. The tool can be used for multiple functions. The stainless steel pick can be used to remove debris from the hoof with ease. The boars-hair brush can be used to dispense a perfect amount of oil and then to apply the oil to the hoof. The hoof brush can be used for additional cleaning. The tool is easily refillable and dispenses a desired amount of oil via the press button near the brush(es). The multifunctional tool is intended to save a considerable amount of time while caring for horses. The brush can be constructed using plastic, metal, and other suitable materials. Exact size, measurement, construction, and design specifications may vary upon manufacturing. Preferred embodiments have the hoof dressing brush at the top (under the attached flipped top cap) which may be made from boars' hair or a natural type of bristle, not silicone in preferred embodiments.

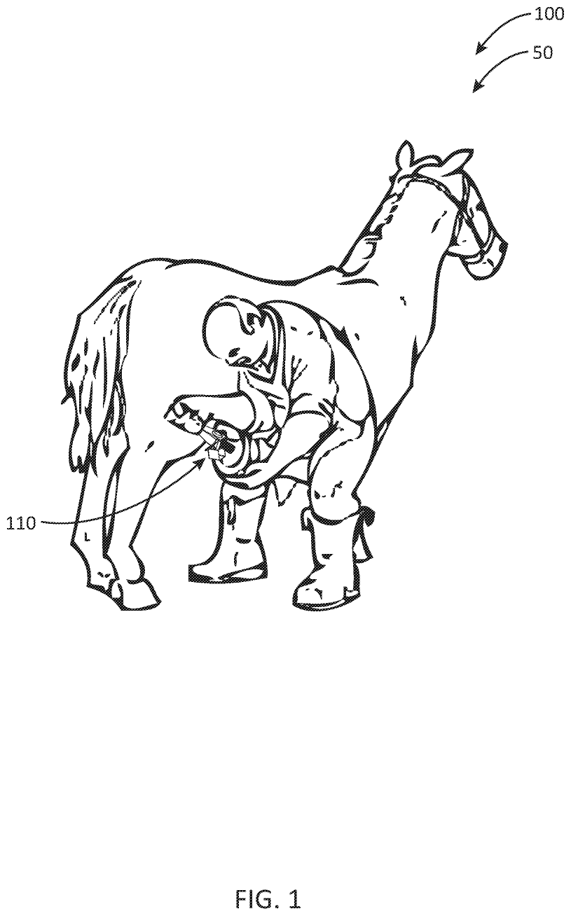

Referring now more specifically to the drawings by numerals of reference, there is shown in FIGS. 1-5, various views of a dual hoof pick system 100.

FIG. 1 shows a dual hoof pick system 100 during an ‘in-use’ condition 50, according to an embodiment of the present disclosure. Here, the dual hoof pick system 100 may be beneficial for use by a user to efficiently care for horse hooves. As illustrated, the dual hoof pick system 100 may include a dual hoof pick assembly 110 having a tool-body 120 including a handle 122; an interior volume 124; a first-brush 130; a second-brush 140; and a pick 150; wherein the dual hoof pick assembly 110 is configured for removing debris from and dispensing oil to at least one hoof of an animal such as a horse.

The pick 150 of the dual hoof pick system 100 preferably comprises stainless steel; however, it is envisioned that the pick 150 may comprise other suitable materials. The second-brush 140 comprises a hoof-brush 142. The handle 122 comprises the interior volume 124 in preferred embodiments; wherein the interior volume 124 is accessible via a hinged cap 126 for filling the volume of oil. Other suitable means for accessing the interior volume 124 are also envisioned.

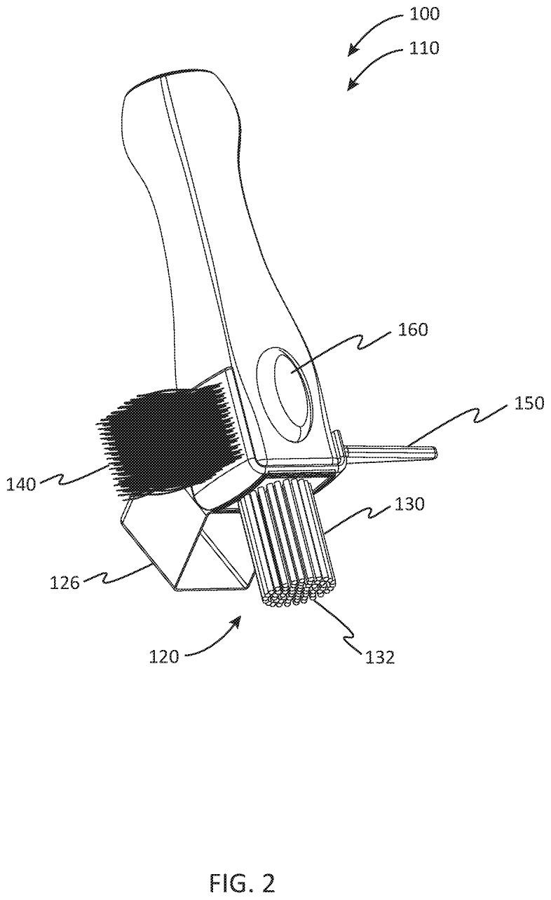

The first-brush 130 of the dual hoof pick system 100 comprises a boars-hair brush 132 configured for dispensing oil for application to the at least one hoof of a horse or similar animal. The boars-hair brush 132 is protected via the hinged cap 126 to promote durability. The hinged cap 126 preferably comprises plastic, but other suitable materials may be used. In preferred embodiments the dual hoof pick system 100 further comprises a dispensing button 160. Other dispensing means may be used. Relationally speaking, the first-brush 130 and the second-brush 140 are preferably oriented perpendicular to each other, as shown in FIG. 2.

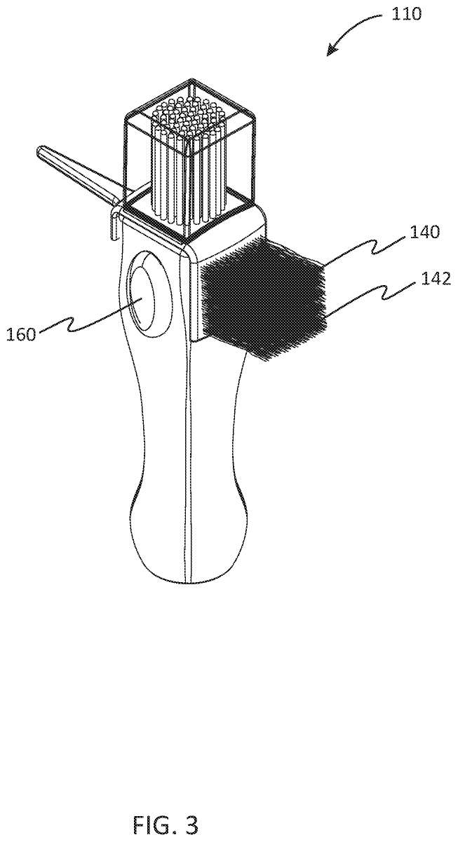

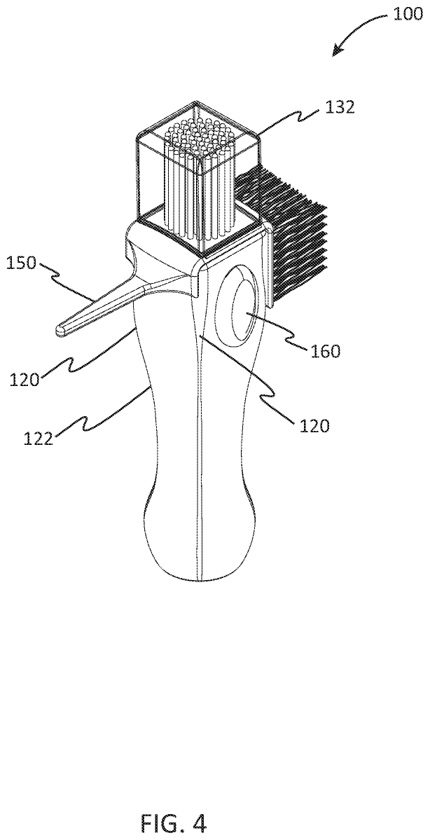

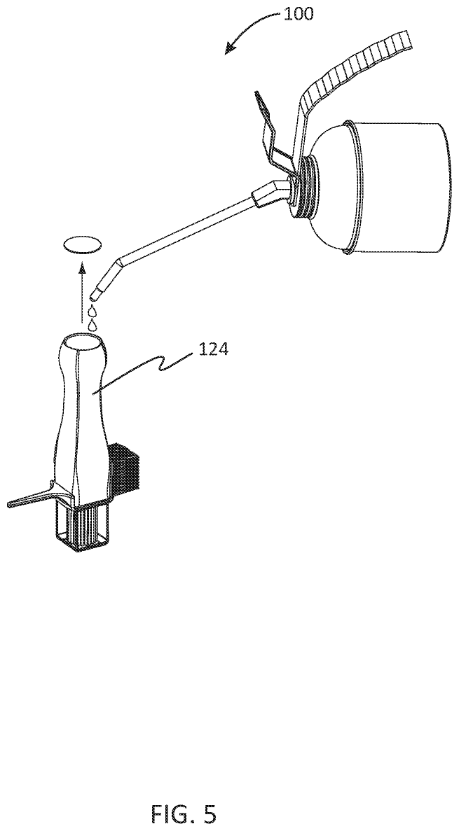

FIG. 3 is a perspective view of the first-brush 130 of the dual hoof pick system of FIG. 1, according to an embodiment of the present disclosure. FIG. 4 shows a perspective view of the pick 150 of the dual hoof pick system of FIG. 1 and FIG. 5 is a perspective view showing how oil may be added to the dual hoof pick system of FIG. 1. As shown, the pick 150 and the second-brush 140 are preferably oriented co-planar to each other with the tool-body 120 located between them. The pick 150 and the first-brush 130 are preferably oriented perpendicular to each other.

The dispensing button 160 of the dual hoof pick system 100 is flexible and comprises a convex curvature (FIGS. 2-4) that is able to move to a concave curvature (state) when pushed to expel the oil from the interior volume 124 when depressed and naturally return to the convex curvature (state) ready for a subsequent-application-press. Relationally speaking the dispensing button 160 is preferably located between the second-brush 140 and the pick 150; the dispensing button 160 located on and integral with the tool-body 120. The dispensing button 160 is preferably able to extend into the tool-body 120 when pressed (moving from a concave state into a convex state and back). The second-brush 140 comprises bristles more flexible than those of the first-brush 130 in preferred embodiments. Those with ordinary skill in the art will now appreciate that upon reading this specification and by their understanding the art of bristles, picks, dispensing means as described herein, they will understand the methods, means and materials available for use.

According to one embodiment, the dual hoof pick system 100 may be arranged as a kit. In particular, the dual hoof pick system 100 may further include a set of instructions and oil(s). An oil refilling device may be used such as syringe style or those sold that squeeze readily and have a pointed tip with a small cap on them). The instructions may detail functional relationships in relation to the structure of the dual hoof pick system 100 such that the dual hoof pick system 100 can be used, maintained, or the like, in a preferred manner.

A method of use of the dual hoof pick system 100 may include one or more components or features of the dual hoof pick system 100 as described above. As illustrated, the method of use may include the steps of: step one, providing a dual hoof pick assembly having a tool-body including a handle; an interior volume; a first-brush; a second-brush; a hinged cap; a dispensing button; and a pick (comprising preferably stainless steel); step two, cleaning debris from at least one hoof of a horse; and step three, applying oil to the at least one hoof of a horse. The method may further comprise step four: refilling the tool-body with oil as needed for dispensing.

It should be noted that the steps described in the method of use can be carried out in many different orders according to user preference. The use of “step of” should not be interpreted as “step for”, in the claims herein and is not intended to invoke the provisions of 35 U. S.C. § 112(f). It should also be noted that, under appropriate circumstances, considering such issues as design preference, user preferences, marketing preferences, cost, structural requirements, available materials, technological advances, etc., other methods for use of the dual hoof pick system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A dual hoof pick system, the system comprising:
a dual hoof pick assembly having
a tool-body including
a handle;
an interior volume;
a first-brush;
a second-brush; and
a pick; and
wherein said dual hoof pick assembly is configured for removing debris from and dispensing oil to an animal hoof.

2. The dual hoof pick system of claim 1, wherein the pick comprises stainless steel.

3. The dual hoof pick system of claim 2, wherein the second-brush comprises a hoof-brush.

4. The dual hoof pick system of claim 3, wherein the handle comprises the interior volume.

5. The dual hoof pick system of claim 4, wherein the interior volume is accessible via a hinged cap.

6. The dual hoof pick system of claim 5, wherein the first-brush comprises a boars-hair brush configured for dispensing oil to the animal hoof

7. The dual hoof pick system of claim 6, wherein the boars-hair brush is protected via the hinged cap.

8. The dual hoof pick system of claim 7, wherein the hinged cap comprises plastic.

9. The dual hoof pick system of claim 8, further comprising a dispensing button.

10. The dual hoof pick system of claim 9, wherein the first-brush and the second-brush are oriented perpendicularly to each other.

11. The dual hoof pick system of claim 10, wherein the pick and the second-brush are oriented coplanerly to each other.

12. The dual hoof pick system of claim 11, wherein the pick and the first-brush are oriented perpendicularly to each other.

13. The dual hoof pick system of claim 12, wherein the dispensing button is flexible and comprises a convex curvature that is able to move to a concave curvature when depressed to express oil from said interior volume and naturally return to the convex curvature ready for a subsequent-application-press.

14. The dual hoof pick system of claim 13, wherein the dispensing button is located between the second-brush and the pick on the tool-body.

15. The dual hoof pick system of claim 14, wherein the dispensing button extends into the tool-body when pressed.

16. The dual hoof pick system of claim 1, wherein the second-brush comprises bristles more flexible than those of the first-brush.

17. A dual hoof pick system, the system comprising:
a dual hoof pick assembly having
a tool-body including
a handle with an interior volume;
a first-brush;
a second-brush;
a hinged cap;
a dispensing button; and
a pick comprising stainless steel; and
wherein the second-brush comprises a hoof-brush;
wherein the interior volume is accessible via the hinged cap;
wherein the boars-hair brush is protected by the hinged cap;
wherein the hinged cap comprises plastic;
wherein the dual hoof pick assembly is configured for removing debris from and dispensing oil to a horse hoof;
wherein the first-brush comprises a boars-hair brush configured for dispensing the oil for application to a horse hoof;
wherein the first-brush and the second-brush are oriented perpendicularly to each other;
wherein the pick and the second-brush are oriented coplanerly to each other;
wherein the pick and the first-brush are oriented perpendicularly to each other;
wherein the dispensing button is flexible and comprises a convex curvature that is able to move to a concave curvature when depressed to expel the oil from the interior volume and naturally return to the convex curvature ready for a subsequent-application-press;
wherein the dispensing button is located between the second-brush and the pick, on the tool-body; and
wherein the dispensing button partially extends into the tool-body when pressed.

18. The dual hoof pick system of claim 17, further comprising a set of instructions; and
wherein the dual hoof pick system is arranged as a kit.

19. A method of use for the dual hoof pick system, the method comprising the steps of:
providing a dual hoof pick assembly having
a tool-body including
a handle;
an interior volume;
a first-brush;
a second-brush;
a hinged cap;
a dispensing button; and
a pick comprising stainless steel;
cleaning debris from a horse hoof; and
applying oil to a horse hoof.

20. The method of claim 19, further comprising the step of refilling oil into the tool-body as needed for dispensing.
